(19) United States
(12) Patent Application Publication
(10) Pub. No.: US 2022/0401837 A1
(43) Pub. Date: Dec. 22, 2022

(54) PROGRAM AND INFORMATION PROCESSING APPARATUS THAT PROVIDE GAME TO PLAYER

(71) Applicants: Aniplex Inc., Tokyo (JP); DeskWorks Inc., Osaka (JP)

(72) Inventor: Tomoharu Fujii, Tokyo (JP)

(73) Assignees: Aniplex Inc., Tokyo (JP); DeskWorks Inc., Osaka (JP)

(21) Appl. No.: 17/836,253

(22) Filed: Jun. 9, 2022

(30) Foreign Application Priority Data
Jun. 21, 2021 (JP) 2021-102682

(51) Int. Cl. A63F 13/52

(52) U.S. Cl. CPC A63F 13/52

(57) ABSTRACT

Provided is a program that causes a computer to have an agent as a guide in a game provide the game to a player. The program for the computer includes displaying, in a first region of a display unit, an image of the game played by the player, displaying, in a second region of the display unit, an operation object for the player to operate the game, and controlling progress of the game by receiving input made on the operation object. The displaying the operation object includes displaying an operation object corresponding to the game played by the player.

### CROSS REFERENCE TO RELATED APPLICATION

This application claims the benefit of Japanese Priority Patent Application JP 2021-102682 filed Jun. 21, 2021, the entire contents of which are incorporated herein by reference.

### BACKGROUND

The present disclosure relates to a program and an information processing apparatus in which an agent as a guide in a game provides the game to a player.

A role playing game is a game in which a player operates a game character to overcome challenges provided in a virtual space of the game and achieve a goal. Various types of role playing games are currently distributed.

### SUMMARY

The world view and the theme of a game are important factors for making the player immersed in the game. The player is drawn into the world of the game when the player feels and appreciates the world view and the theme of the game, and the player can enjoy playing the game. Therefore, it is desirable to provide a new game world to a player.

An embodiment of the present disclosure relates to a program that causes a computer to have an agent as a guide in a game provide the game to a player. The program for the computer includes displaying, in a first region of a display unit, an image of the game played by the player, displaying, in a second region of the display unit, an operation object for the player to operate the game, and controlling progress of the game by receiving input made on the operation object. The displaying the operation object includes displaying an operation object corresponding to the game played by the player.

Another embodiment of the present disclosure provides an information processing apparatus in which an agent as a guide in a game makes the game progress. The information processing apparatus includes a first display processing unit that displays, in a first region, an image of the game played by the player, a second display processing unit that displays, in a second region, an operation object for the player to operate the game, and a progress control unit that controls progress of the game by receiving input made on the operation object. The second display processing unit displays an operation object corresponding to the game played by the player.

Note that any combination of the constituent elements converted between a system, an information processing apparatus that executes a game program, a recording medium that stores the game program, and the like is also effective as embodiments of the present disclosure.

### BRIEF DESCRIPTION OF THE DRAWINGS

FIG. 1 depicts an example of an appearance of an information processing apparatus;

FIG. 2 depicts a hardware configuration of the information processing apparatus;

FIG. 3 depicts functional blocks of a processing unit;

FIG. 4 is a diagram for describing partitioning of regions of a display unit;

FIG. 5 depicts an example in which some of objects used in a game are arranged in a second region;

FIG. 6 depicts an example of a game screen;

FIG. 7 depicts an example of a game screen;

FIG. 8 depicts an example of the game screen;

FIG. 9 depicts an example of the game screen; and

FIG. 10 depicts an example of the game screen.

### DETAILED DESCRIPTION OF THE PREFERRED EMBODIMENT

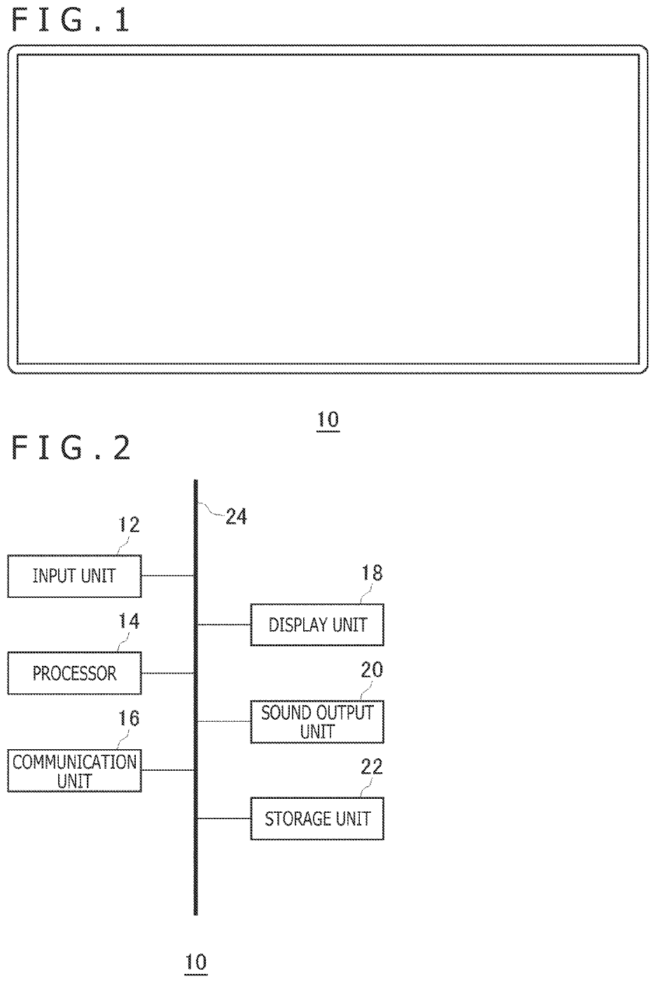

FIG. 1 illustrates an example of an appearance of an information processing apparatus 10 according to an embodiment. The information processing apparatus 10 is a terminal apparatus having game software installed thereon, and a player who is a user operates the information processing apparatus 10. The information processing apparatus 10 may be a portable electronic device such as a smartphone and a tablet terminal, or may be a stationary electronic device such as a personal computer. The information processing apparatus 10 may also be a portable or stationary game machine.

FIG. 2 illustrates a hardware configuration of the information processing apparatus 10. The information processing apparatus 10 includes an input unit 12, a processor 14, a communication unit 16, a display unit 18, a sound output unit 20, and a storage unit 22. The components are connected to one another through a bus 24. The information processing apparatus 10 of the embodiment installs game software and operates as a game device.

The input unit 12 is a user interface to which the user inputs an operation. In a case where the information processing apparatus 10 is a portable terminal apparatus such as a smartphone, the input unit 12 may be a touch screen for touch operation. In a case where the information processing apparatus 10 is a terminal apparatus such as a personal computer, the input unit 12 may be a keyboard or a mouse. In a case where the information processing apparatus 10 is a game machine, the input unit 12 may be a game controller including an analog stick or an operation button. In any case, it is sufficient that the input unit 12 allows the user to input an operation for the game.

The processor 14 is a unit that comprehensively controls the action of the information processing apparatus 10, and the processor 14 typically includes a central processing unit (CPU). The processor 14 reads and executes a game program stored in the storage unit 22 and generates a game image and game sound. The processor 14 outputs the game image and the game sound from the display unit 18 and the sound output unit 20. It is preferable that the processor 14 include a graphics processing unit (GPU) specific to image processing.

The communication unit 16 may have a wireless communication function and may be connected to the Internet. The communication unit 16 may download game software from a content server through the Internet and install the game software on the storage unit 22. Note that a wired cable may be used to connect the communication unit 16 to a router or the like and connect the communication unit 16 to the Internet.

The display unit 18 is a display device that displays the game image generated by the processor 14. The information processing apparatus 10 of the embodiment may include a touch panel including the display unit 18 as a display and the input unit 12 as a touch screen that are placed one on another. The user can directly touch a graphical user interface (GUI) displayed on the display unit 18. The sound output unit 20 may be a speaker that outputs the game sound generated by the processor 14.

The storage unit 22 is a storage device including a random-access memory (RAM) that is a volatile memory and a read-only memory (ROM) that is a non-volatile memory. The storage unit 22 stores game software downloaded from a content server. Note that the game software may be installed on the storage unit 22 from a ROM medium recording the game software.

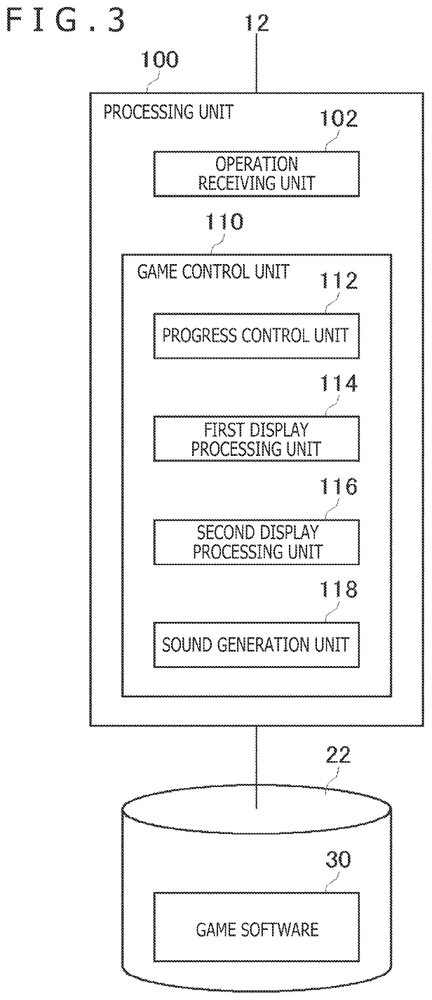

FIG. 3 illustrates functional blocks of a processing unit 100 in the information processing apparatus 10. The processing unit 100 includes an operation receiving unit 102 and a game control unit 110. The game control unit 110 is a game execution unit that executes game software 30, and the game control unit 110 includes a progress control unit 112, a first display processing unit 114, a second display processing unit 116, and a sound generation unit 118.

The functional blocks illustrated in FIG. 3 can be implemented by the processor 14 of a computer, an element and an electronic circuit such as a memory, and a mechanical apparatus in terms of hardware, and can be implemented by system software, the game software 30, and the like in terms of software. The functional blocks depicted here are implemented by cooperation between the hardware and the software. The game software 30 is installed on the storage unit 22 in the embodiment, and the processor 14 of the information processing apparatus 10 reads out the game software 30 to a main memory and executes the game software 30 to implement the functions of the blocks of the processing unit 100. Those skilled in the art will understand that the functional blocks can be implemented in various forms based on combinations of the hardware and the software.

The operation receiving unit 102 receives an operation input that is made by the user on the game and that is input to the input unit 12, and transfers the input information to the game control unit 110. In a case where the input unit 12 is a touch screen, the operation receiving unit 102 acquires, from the input unit 12, coordinate values (xy coordinate values) that indicate a touch position on the touch screen, and provides the coordinate values to the game control unit 110.

The progress control unit 112 controls the progress of the game according to the input information provided from the operation receiving unit 102. The progress control unit 112 of the embodiment causes an agent as a guide in the game to sequentially provide a plurality of mini games to the player and thus helps the game to progress. The game ends when the player completes all of the mini games. In the game world constructed in the game of the embodiment, the agent is set as a game creator that has created the game, and the agent sequentially provides a plurality of mini games created by the agent to the player while talking to the player. The agent teaches the player how to play the mini games, and intervenes with the progress of the mini games, so that the player can enjoy the mini games. The player receives information regarding the game from the agent and completes the mini games provided one after another.

All of the mini games are written down on a notebook (record book) by the agent, and the player sequentially plays the mini games written on the notebook (hereinafter, simply referred to as a “note”). Therefore, the page is turned when one mini game is completed, and the mini game written on the next page is started. While receiving hints from the agent, the player plays the mini games written on the note opened on a desk.

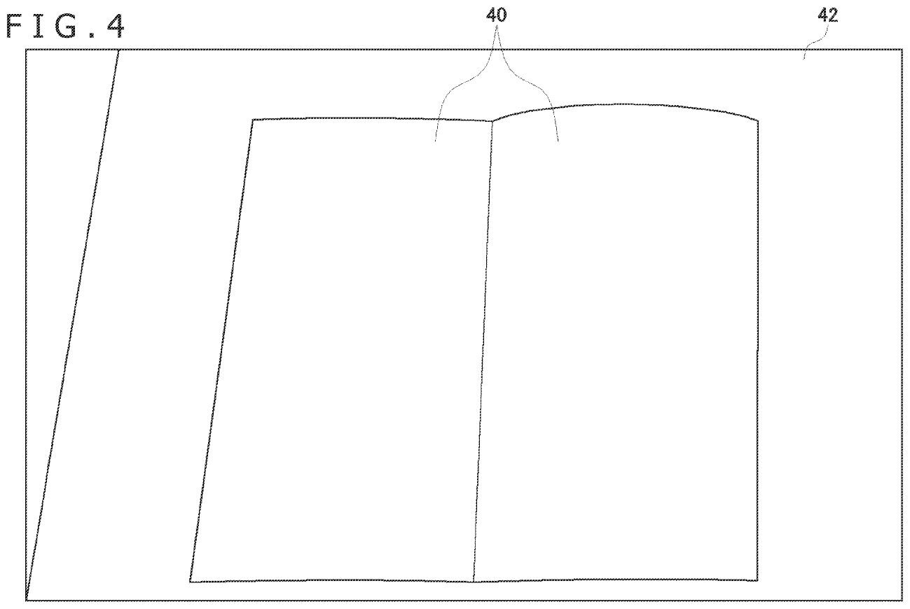

FIG. 4 is a diagram for describing partitioning of regions of the display unit 18. The display unit 18 includes a first region 40 and a second region 42 that is a region other than the first region 40. The first region 40 displays images of the mini games. The game of the embodiment provides a game world in which the note with the mini games is opened on the desk. The first display processing unit 114 displays, in the first region 40, images of the mini games written on the note. The second region 42 is a region surrounding the first region 40, and the second region 42 displays the desk on which the note is placed. Once the player completes the mini game on the opened page, the first display processing unit 114 turns the page and displays, in the first region 40, an image of a new mini game on the next page.

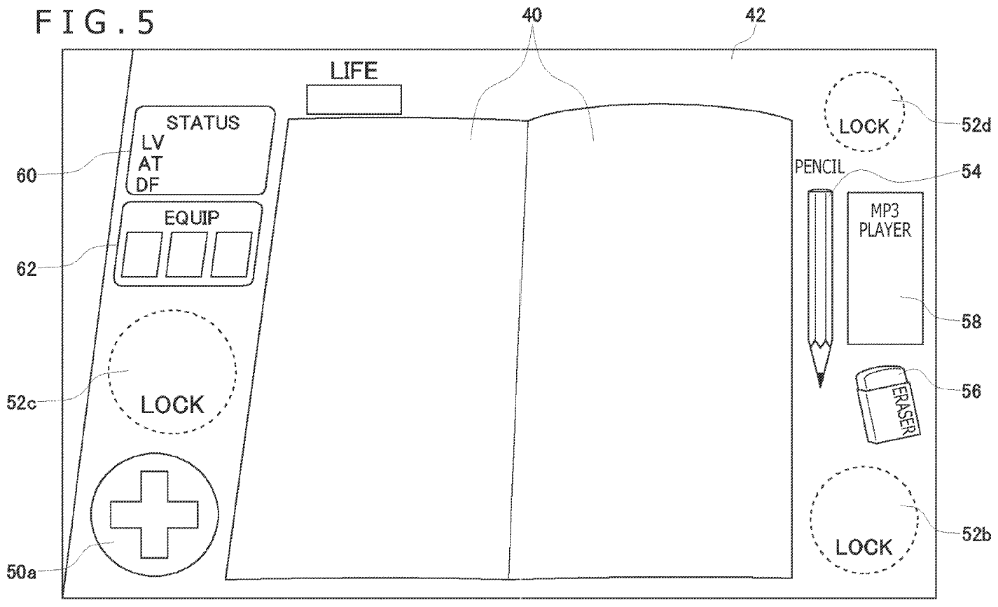

FIG. 5 illustrates an example in which some of objects used in the game are arranged in the second region 42. The second display processing unit 116 displays, in the second region 42 set around the first region 40, various objects used in the game.

An operation object 50a that is operated by the player to play the mini game is arranged on the lower left of the second region 42. The operation object 50a is a directional pad, and the player mainly operates the operation object 50a to move a game character. Object arrangement spaces 52b, 52c, and 52d are places where other operation objects are arranged. In the state illustrated in FIG. 5, the operation objects are not arranged yet.

Intervention objects 54 and 56 for the agent to intervene with the progress of the mini game are arranged on the right side of the second region 42. The intervention object 54 is a pencil, and the agent uses the pencil to rewrite part of the mini game displayed in the first region 40. The intervention object 56 is an eraser, and the agent uses the eraser to erase part of the mini game displayed in the first region 40. The agent can use the intervention objects 54 and 56 to update the game content displayed in the first region 40 while the player views the game content. The update of the content of the game being played is based on the world view that the agent is the one who has created the mini game and who is allowed to freely change the game content.

A music reproduction object 58 is an object that reproduces music, and the music reproduction object 58 reproduces music selected by the agent according to the scene displayed in the first region 40. A status display region 60 displays the status of the game character operated by the player, and an equipment display region 62 displays the equipment for the game character operated by the player.

The second display processing unit 116 displays the operation object 50a, the intervention objects 54 and 56, and the like in the second region 42 before the player starts to operate the game character. Note that the operation objects are not displayed in the object arrangement spaces 52b, 52c, and 52d at the start of the first mini game, and the second display processing unit 116 displays the operation objects in the object arrangement spaces in the second region 42 when predetermined conditions are satisfied after the start of the first mini game. The object arrangement spaces 52b, 52c, and 52d are formed at predetermined positions with respect to the first region 40. In other words, the operation objects used by the player are arranged on the game screen in a predetermined positional relation with respect to the note provided with the mini games.

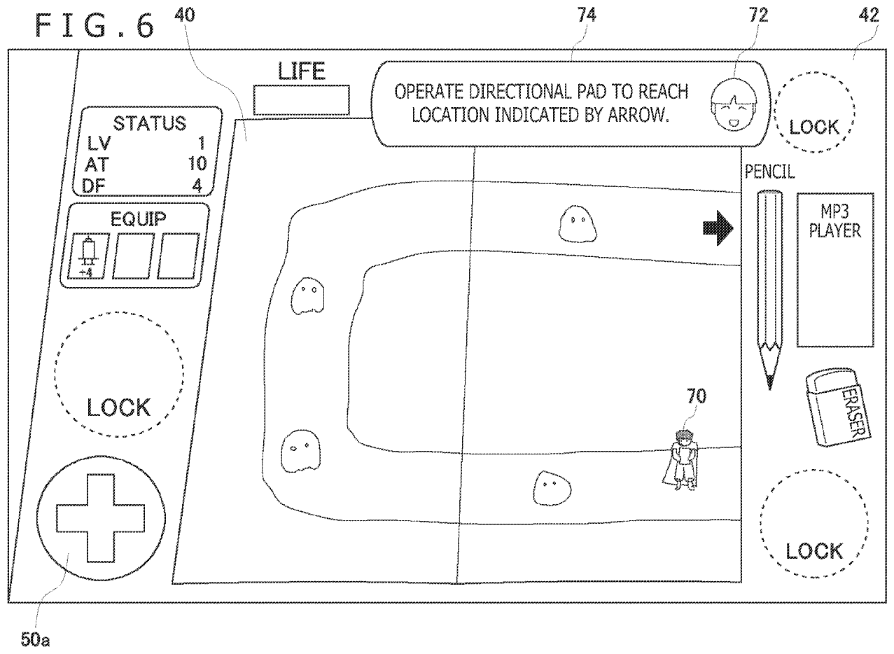

FIG. 6 illustrates an example of the game screen. Once the progress control unit 112 starts the mini game, the first display processing unit 114 displays the image of the mini game in the first region 40. The progress control unit 112 may display, in a message region 74, how to play the displayed mini game. An icon of an agent 72 is displayed in the message region 74, and the agent 72 as a game creator talks to the player. The player can thus receive a hint from the agent and progress through the game.

The operation receiving unit 102 receives an operation input that is made by the user on the game and that is input to the input unit 12, and provides information regarding the input made by the user to the game control unit 110. The progress control unit 112 receives, from the information regarding the input made by the user, the input made on the operation object 50a and controls the progress of the mini game. In the embodiment, the operation receiving unit 102 acquires, from the input unit 12, coordinate values (xy coordinate values) that indicate a position touched by the user. The progress control unit 112 recognizes that the touch position is the position of an arrow key of the operation object 50a, and receives input made on the operation object 50a. In the example illustrated in FIG. 6, the progress control unit 112 uses the input made on the operation object 50a, which is a directional pad, to move a game character 70. In another mini game, the progress control unit 112 may use the input made on the operation object 50a, to perform a game operation other than the movement of the game character 70. The mini game illustrated in FIG. 6 is completed when the game character 70 goes along the road while avoiding the slime and reaches the position indicated by the arrow.

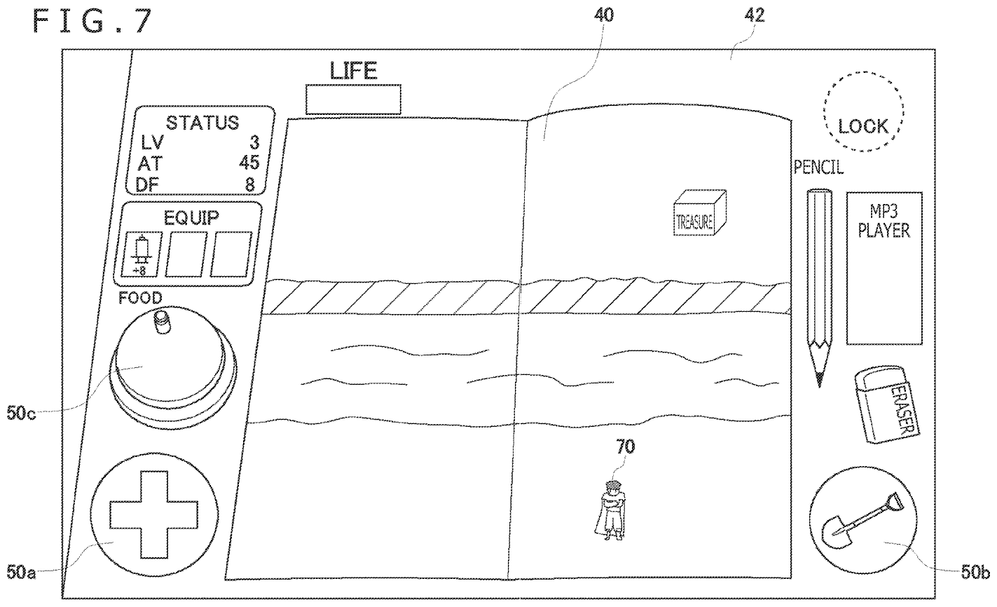

FIG. 7 illustrates an example of another game screen. The first display processing unit 114 displays an image of the mini game in the first region 40, and the second display processing unit 116 displays operation objects corresponding to the mini game in the second region 42.

In the example, the first display processing unit 114 displays, on the left side of the second region 42, the operation object 50a, which is a directional pad, and an operation object 50c used for providing a recovery item to the game character 70. The operation object 50c may have an appearance of a call bell. The first display processing unit 114 also displays, on the right side of the second region 42, an operation object 50b used for operating a shovel to dig the ground.

Compared to the game screen illustrated in FIG. 6, the operation object 50 used for providing the recovery item and the operation object 50b used for operating the shovel are newly displayed in the second region 42 on the game screen illustrated in FIG. 7. The second display processing unit 116 displays the operation objects 50b and 50c at predetermined positions in the second region 42 when predetermined conditions are satisfied in the progress of the game. For example, the second display processing unit 116 may display the operation object 50c when the game character 70 acquires the recovery item.

The second display processing unit 116 displays the operation object 50b when a tool is to be used in the progress of the game. Note that, in the example illustrated in FIG. 7, the second display processing unit 116 displays the operation object 50b used for operating the shovel. In another mini game, the second display processing unit 116 may display the operation object 50b used for operating another tool.

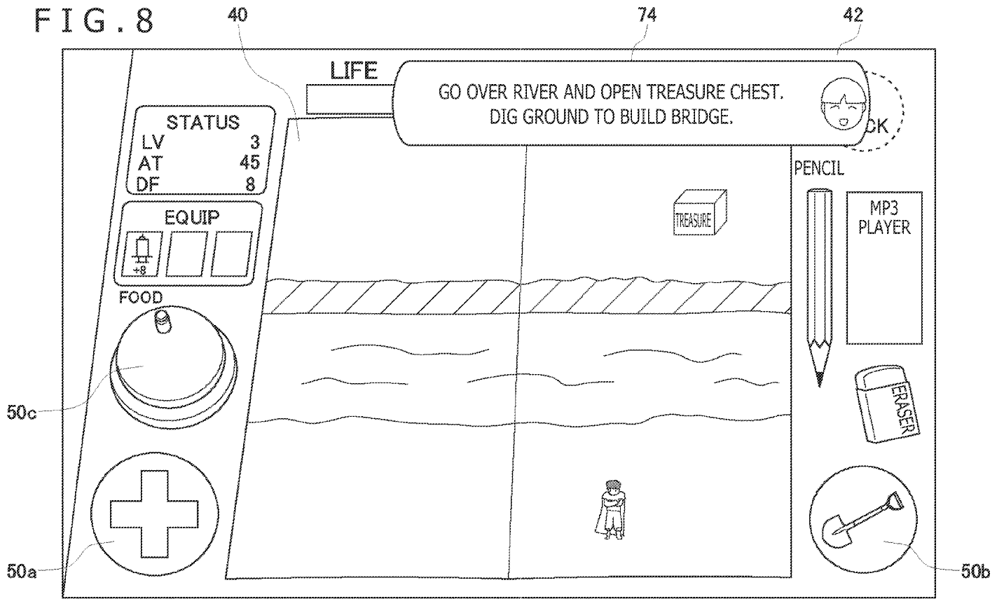

FIG. 8 illustrates an example of the game screen. The progress control unit 112 displays how to play the mini game, in the message region 74 at the start of the mini game. When the player sees how to play the mini game, which is displayed in the message region 74, the player recognizes that the player can build a bridge over the river by tapping the operation object 50b.

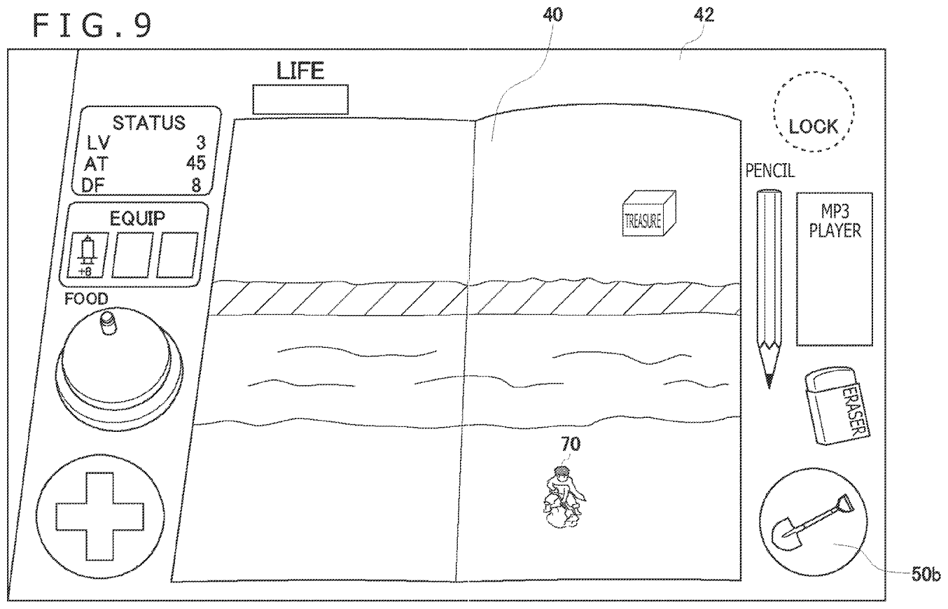

FIG. 9 illustrates an example of the game screen. When the player taps the operation object 50b, the progress control unit 112 receives input made on the operation object 50b. Once the progress control unit 112 receives the input made on the operation object 50b, the progress control unit 112 causes the game character 70 to make an action of holding the shovel to dig the ground. The first display processing unit 114 generates an image of the game character 70 using the shovel to dig the ground and displays the image in the first region 40.

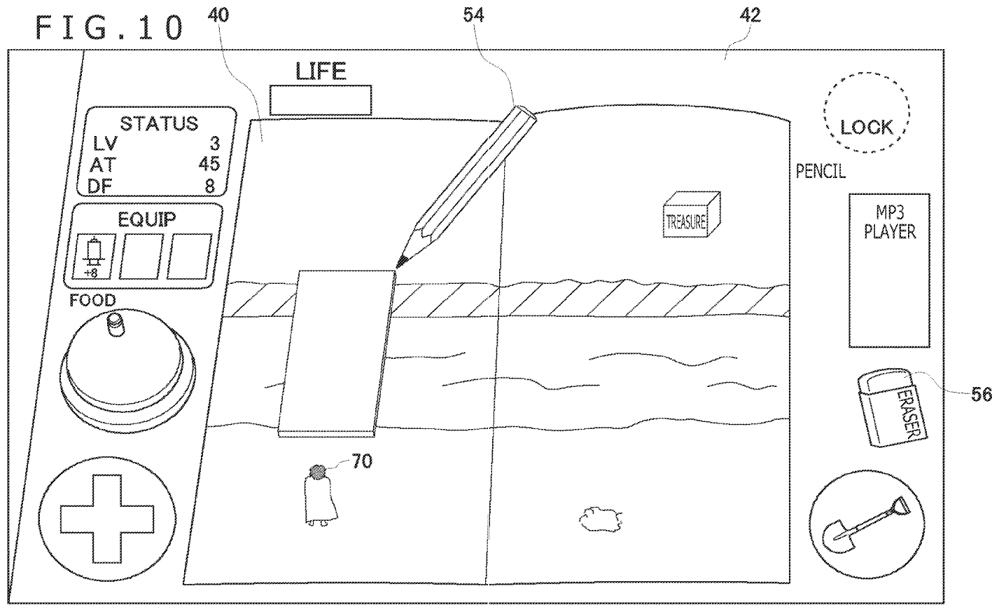

FIG. 10 illustrates an example of the game screen. When the game character 70 uses the shovel to dig the ground, the progress control unit 112 determines that a condition for occurrence of an event of building a bridge is met. The progress control unit 112 moves the intervention objects 54 and 56 in the first region 40 to trigger the event of building a bridge. Specifically, the progress control unit 112 moves the intervention object 56, which is an eraser, and erases the pictures of the bank, the river, and the like at positions where a bridge is to be built. The progress control unit 112 moves the intervention object 54, which is a pencil, to the blank part and depicts a bridge. The agent updates the image of the mini game in the game world of the embodiment. When the agent updates the image, the progress control unit 112 may notify the player that the agent is updating the image of the mini game. As the progress control unit 112 moves the intervention objects 54 and 56 and updates the image of the mini game, the player can view the process of building the bridge as a result of digging the hole, and can enjoy the dynamic change in the scene.

The condition for occurrence of the event of building the bridge may be met in a case where the game character uses the shovel to dig an appropriate place (place where a switch used for building the bridge is buried). For example, in a case where there is a restriction that, if the event occurrence condition is not met after the player digs a certain place, the dug place needs to be filled before the player starts digging another place, the progress control unit 112 may put a mark on the place dug once. By seeing the mark, the player can recognize the place dug once where the event occurrence condition is not met. This can eliminate the burden of the player digging the hole again. In this way, the progress control unit 112 may mark an action record of the game character 70 to assist the game operation of the player.

The present disclosure has been described based on the embodiment. The embodiment is illustrative, and those skilled in the art will understand that various modifications can be made on the combinations of the constituent elements and the processes described in the embodiment and that the modifications are also within the scope of the present disclosure.

In the embodiment, the progress control unit 112 causes the agent to sequentially provide a plurality of mini games to the player and helps the game progress. In a modification, the progress control unit 112 may provide a game that is to be continuously executed, instead of providing a plurality of mini games that are to be intermittently executed. In the modification, the first display processing unit 114 displays, in the first region 40, an image of the game played by the player, and the second display processing unit 116 displays, in the second region 42, operation objects corresponding to the game played by the player.

What is claimed is:

1. A program that causes a computer to have an agent as a guide in a game provide the game to a player,
the program for the computer, comprising:
displaying, in a first region of a display unit, an image of the game played by the player;
displaying, in a second region of the display unit, an operation object for the player to operate the game; and
controlling progress of the game by receiving input made on the operation object, wherein
the displaying the operation object includes displaying an operation object corresponding to the game played by the player.

2. The program according to claim 1, wherein the displaying the operation object includes not displaying the operation object in the second region at a start of the game, but displaying the operation object in the second region when a predetermined condition is satisfied after the start of the game.

3. The program according to claim 1, wherein the displaying the operation object includes displaying the operation object at a predetermined position in the second region.

4. The program according to claim 1, wherein the second region is set around the first region.

5. The program according to claim 1, wherein
the displaying the operation object includes displaying, in the second region, an intervention object for the agent to intervene with the progress of the game, and
the controlling the progress of the game includes moving the intervention object in the first region to trigger an event.

6. The program according to claim 5, wherein the controlling the progress of the game includes moving the intervention object in the first region to update the image of the game.

7. The program according to claim 1, wherein
the controlling the progress of the game includes having the agent sequentially provide a plurality of mini games to the player, and
the displaying the operation object includes displaying an operation object corresponding to a mini game.

8. The program according to claim 7, wherein the displaying the operation object includes displaying, in the second region, an intervention object for the agent to intervene with progress of the mini game.

9. An information processing apparatus in which an agent as a guide in a game makes the game progress, the information processing apparatus comprising:
a first display processing unit that displays, in a first region, an image of the game played by the player;
a second display processing unit that displays, in a second region, an operation object for the player to operate the game; and
a progress control unit that controls progress of the game by receiving input made on the operation object, wherein
the second display processing unit displays an operation object corresponding to the game played by the player.
